(19) United States
(12) Patent Application Publication
(10) Pub. No.: US 2015/0138707 A1
(43) Pub. Date: May 21, 2015

(54) Display Device Capable of Exchanging a Display Unit

(71) Applicant: Top Victory Investments Ltd., Kowloon (HK)

(72) Inventors: Ming-Chi Ho, New Taipei City (TW); Hsien-Ming Wu, New Taipei City (TW)

(73) Assignee: Top Victory Investments Ltd., Kowloon (HK)

(21) Appl. No.: 14/082,281

(22) Filed: Nov. 18, 2013

(51) Int. Cl. G06F 1/16

(52) U.S. Cl. CPC G06F 1/1601
USPC 361/679.21

(57) ABSTRACT

A display device disclosed in the present invention includes a base and a first display unit. The base includes a body and an accommodating portion, the accommodating portion is disposed on the body. The first display unit includes a first casing. The first casing has a first dimension and is detachably disposed on the accommodating portion. The first display unit is electrically connected to the base when the first casing is disposed on the accommodating portion. The present invention utilizes the same base to support the display units with different dimensions; meanwhile, the display unit can be assembled with the base at different assembly directions. Comparing to the prior art, the present invention has preferred convenience.

### BACKGROUND OF THE INVENTION

1. Field of the Invention

The present invention relates to a display device, and more particularly, to a display device capable of exchanging a display unit.

2. Description of the Prior Art

A conventional display device includes a display unit and a base. The base has a supporter. A back of the display unit is fixed on an end of the supporter, and the other end of the supporter is fixed on the base. Circuit design of the display unit has to be adjusted accordingly in order to exchange the assembly direction (such as the transverse direction and the vertical direction) of the display unit relative to the base. Besides, the supporter includes a rotary mechanism, which makes structure of the supporter more complicated, enlarges volume and weight of the supporter, and increases manufacturing cost of the supporter. The conventional display device is difficult to exchange the display unit because the supporter is locked on the back of the display unit by screws. The screws are disassembled from the supporter to remove the existent display unit, which results in rough procedure. Thus, design of a display device capable of conveniently exchanging the display unit is an important issue in the related industry.

### SUMMARY OF THE INVENTION

The present invention aims to provide a display device capable of exchanging a display unit, so that the same base can be assembled with the display units with different dimensions, and each display unit can be disposed on the base at different assembly directions.

According to the claimed invention, the display device includes a base and a first display unit. The base includes a body and an accommodating portion, the accommodating portion is disposed on the body. The first display unit includes a first casing. The first casing has a first dimension and is detachably disposed on the accommodating portion. The first display unit is electrically connected to the base when the first casing is disposed on the accommodating portion.

According to an embodiment of the invention, the accommodating portion includes two vertical walls. The vertical walls are arranged in parallel to form a slot, and a first lateral side of the first casing is disposed inside the slot.

According to the embodiment of the invention, the base further includes a first connector disposed inside the slot, and the first display unit further includes a second connector disposed on the first lateral side of the first casing. The first connector is matched with the second connector when the first lateral side is disposed on the accommodating portion so that the base is electrically connected to the first display unit.

According to the embodiment of the invention, the body further includes a pivot hole, and the accommodating portion further includes a shaft. The accommodating portion is rotatably disposed on the body because the pivot hole is assembled with the shaft. The first display unit can be tilted relative to the base when the first lateral side is disposed on the accommodating portion.

According to the embodiment of the invention, the first display unit further includes a third connector disposed on a second lateral side of the first casing. The first connector is matched with the third connector when the second lateral side is disposed on the accommodating portion, so that the base is electrically connected to the first display unit.

According to the embodiment of the invention, the first lateral side and the second lateral side of the first display unit are adjacent to each other.

According to the embodiment of the invention, the second connector and the third connector are female connectors, and the first connector is a male connector.

According to the embodiment of the invention, the base further includes a plurality of buttons. The first display unit is controlled by the buttons when the first display unit is electrically connected to the base.

According to the embodiment of the invention, the display device further includes a second display unit. The second display unit includes a second casing. The second casing has a second dimension and is fit for the accommodating portion. The second display unit is electrically connected to the base when the first display unit is disassembled from the base and the second casing is disposed on the accommodating portion.

According to the embodiment of the invention, the first dimension is substantially greater than the second dimension.

The present invention utilizes separated structures such as the base and the display unit, so that the same base can be used to assemble with the display units with different dimensions; further, the display unit can be conveniently disposed on the base at different assembly directions.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exploded diagram of a display device according to an embodiment of the present invention.

FIG. 2 is a diagram of a base of the display device according to the embodiment of the present invention.

FIG. 3 is a diagram of a first display unit of the display device according to the embodiment of the present invention.

FIG. 4 is a diagram of the first display unit transversely assembled with the base according to the embodiment of the present invention.

FIG. 5 is a diagram of the first display unit vertically assembled with the base according to the embodiment of the present invention.

FIG. 6 is a diagram of the base of the display device matched with different display units according to the embodiment of the present invention.

FIG. 7 is an assembly diagram of a third display unit and the base according to the other embodiment of the present invention.

### DETAILED DESCRIPTION

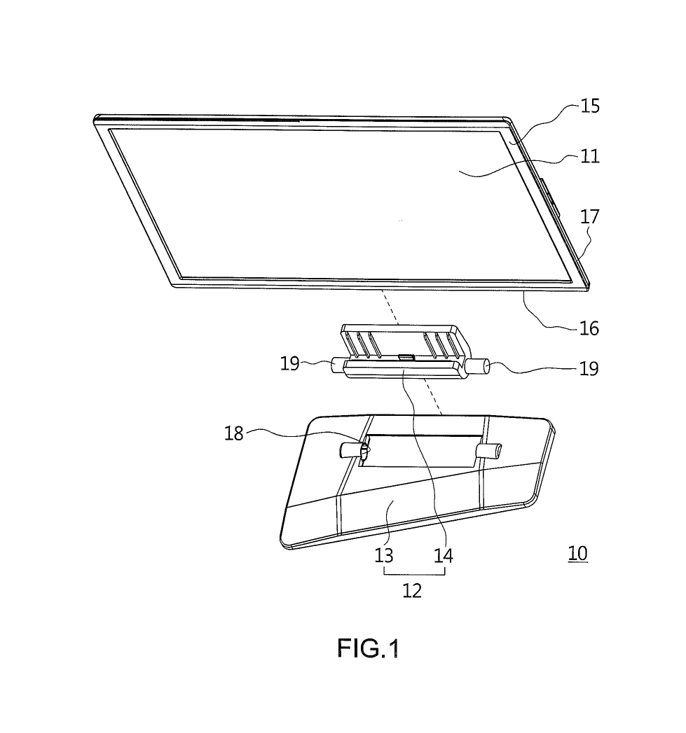

Please refer to FIG. 1. FIG. 1 is an exploded diagram of a display device 10 according to an embodiment of the present invention. The display device 10 includes a first display unit 11 and a base 12. The base 12 includes a body 13 and an accommodating portion 14. The accommodating portion 14 is rotatably disposed on the body 13. The first display unit 11 includes a first casing 15, the first casing 15 has a first dimension and is detachably disposed on the accommodating portion 14. When the first casing 15 is disposed on the accommodating portion 14, the first display unit 11 is electrically connected to the base 12. The first casing 15 includes a first lateral side 16 and a second lateral side 17. In this embodiment, the first lateral side 16 and the second lateral side 17 are adjacent to each other, and the first lateral side 16 is longer than the second lateral side 17. Besides, the body 13 includes a pivot hole 18, the accommodating portion 14 includes a shaft 19. The accommodating portion 14 is rotatably disposed on the body 13 when the pivot hole 18 is assembled with the shaft 19.

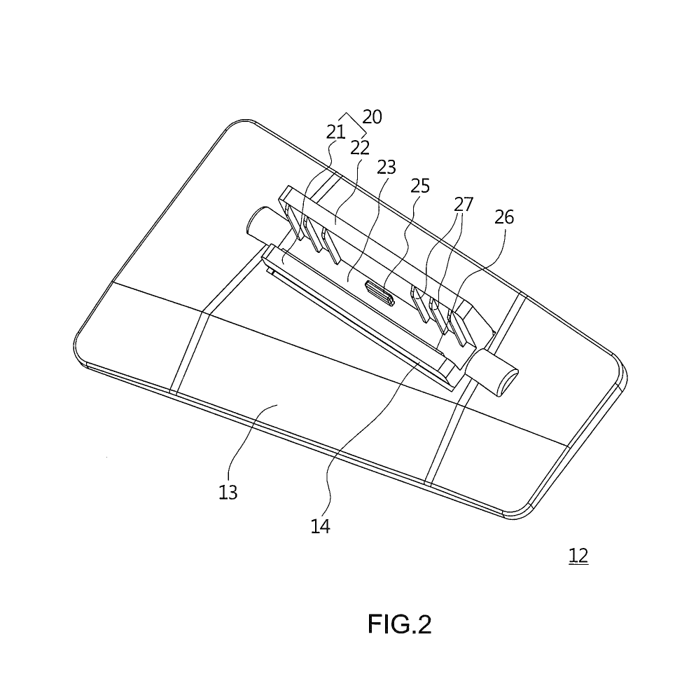

Please refer to FIG. 2. FIG. 2 is a diagram of the base 12 of the display device 10 according to the embodiment of the present invention. The accommodating portion 14 includes two vertical walls 20, which consist of a front vertical wall 21 and a rear vertical wall 22. The front vertical wall 21 and the rear vertical wall 22 are arranged in parallel to form a slot 23. In this embodiment, a height of the front vertical wall 21 is lower than a height of the rear vertical wall 22. The slot 23 is able to be matched with the first lateral side 16 and the second lateral side 17 of the first casing 15. The first casing 15 can be disposed inside the slot 23 via the first lateral side 16 or the second lateral side 17. Further, the base 12 includes a first connector 25 disposed inside the slot 23. The first connector 25 is located between the front vertical wall 21 and the rear vertical wall 22, and is further located on a bottom of the slot 23. In this embodiment, the first connector 25 is a male connector. A front protruding structure 26 is disposed on an inner lateral surface of the front vertical wall 21, and a rear protruding structure 27 is disposed on an inner lateral surface of the rear vertical wall 22. When the first casing 15 is disposed inside the slot 23 via the first lateral side 16 or the second lateral side 17, the first lateral side 16 or the second lateral side 17 can be buckled by the front protruding structure 26 and the rear protruding structure 27, so as to fix the first casing 15 on the accommodating portion 14 stably.

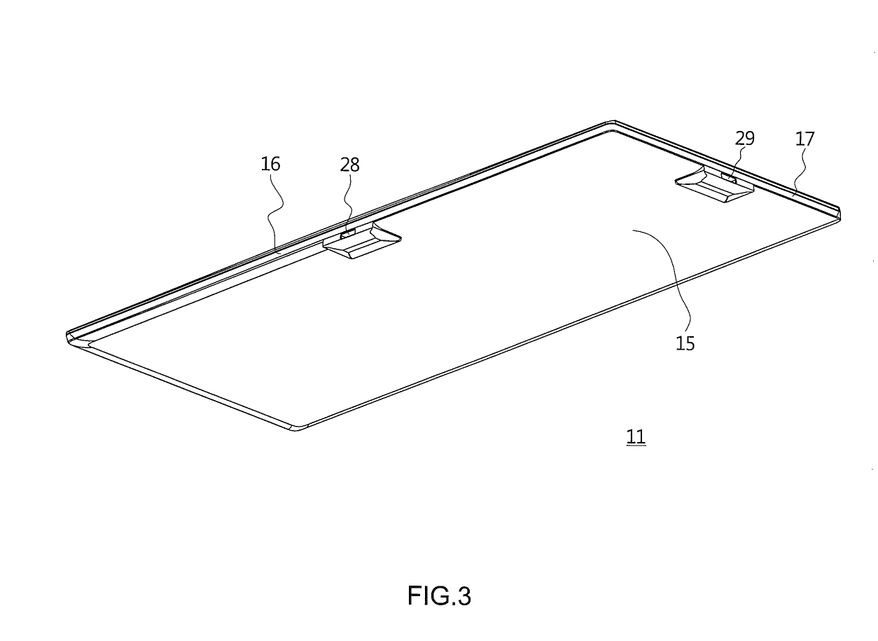

Please refer to FIG. 3. FIG. 3 is a diagram of the first display unit 11 of the display device 10 according to the embodiment of the present invention. The first display unit 11 includes a second connector 28 and a third connector 29. The second connector 28 is disposed on the first lateral side 16 of the first casing 15, and the third connector 29 is disposed on the second lateral side 17 of the first casing 15. The second connector 28 and the third connector 29 are both, but not limited to, disposed on a back of the first casing 15. In this embodiment, the second connector 28 and the third connector 29 are female connectors matched with the first connector 25.

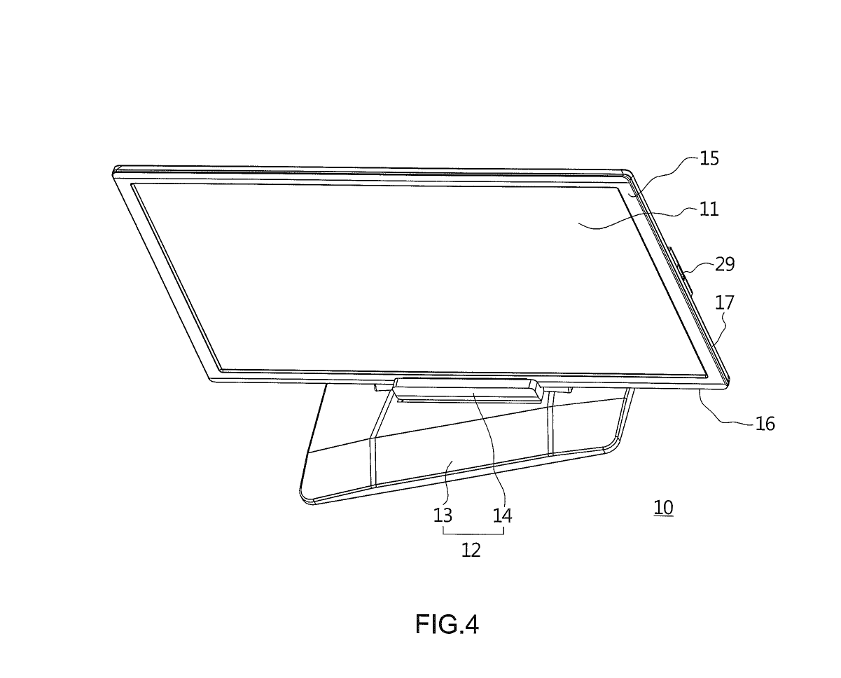

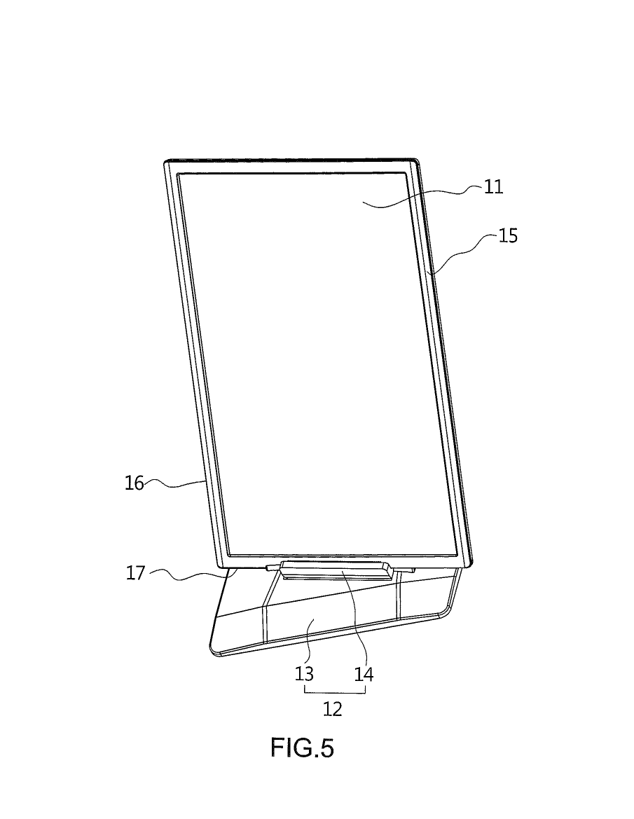

Please refer to FIG. 2 to FIG. 5. FIG. 4 is a diagram of the first display unit 11 transversely assembled with the base 12 according to the embodiment of the present invention. FIG. 5 is a diagram of the first display unit 11 vertically assembled with the base 12 according to the embodiment of the present invention. As shown in FIG. 4, the first connector 25 inserts into the second connector 28 when the first lateral side 16 is disposed on the slot 23 of the accommodating portion 14, so that the base 12 is electrically connected to the first display unit 11. As shown in FIG. 5, the first connector 25 inserts into the third connector 29 when the second lateral side 17 is disposed on the slot 23 of the accommodating portion 14, so that the base 12 is electrically connected to the first display unit 11. Therefore, the first display unit 11 can be adjusted to the transverse mode and the vertical mode conveniently. Because the accommodating portion 14 is rotatably connected to the body 13, the first display unit 11 can be tilted relative to the base 12 when the first casing 15 is disposed on the accommodating portion 14 via the first lateral side 16 or the second lateral side 17.

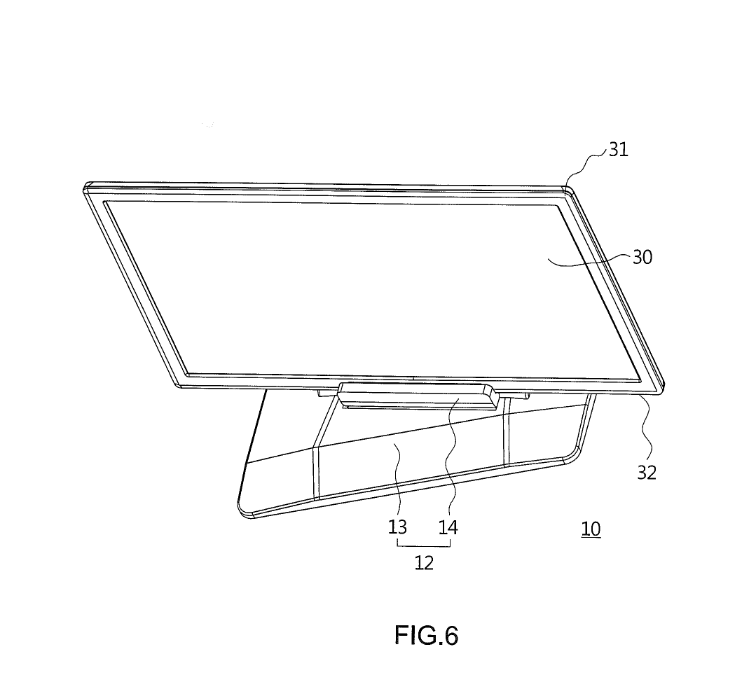

Please refer to FIG. 6. FIG. 6 is a diagram of the base 12 of the display device 10 matched with different display units according to the embodiment of the present invention. As shown in FIG. 6, the display device 10 further includes a second display unit 30. The base 12 of the display device 10 can be suitable for different display units. The second display unit 30 includes a second casing 31, the second casing 31 has a second dimension, and the first dimension is greater than the second dimension. Displaying area of the second display unit 30 is smaller than displaying area of the first display unit 11, and the lateral side 32 of the second casing 31 is still fit for the accommodating portion 14. As the first display unit 11 is disposed on the base 12, the first display unit 11 has to be disassembled from the base 12, and then the lateral side 32 of the second casing 31 of the second display unit 30 can insert into the slot 23; the connector (not shown in figures) disposed on the lateral side 32 of the second casing 31 is matched with the first connector 25, and the second display unit 30 is electrically connected to the base 12. In this embodiment, the connector is disposed on, but not limited to, one lateral side 32 of the second display unit 30.

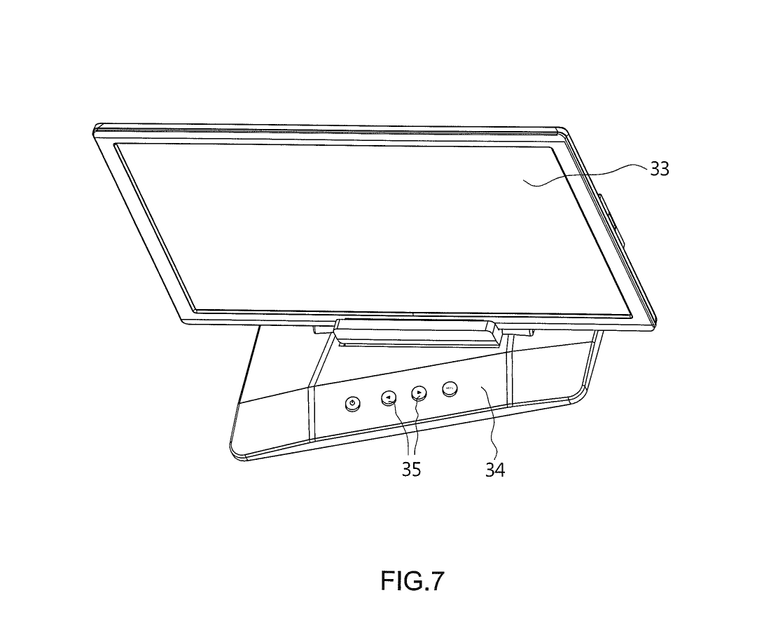

Please refer to FIG. 7. FIG. 7 is an assembly diagram of the third display unit 33 and the base 34 according to the other embodiment of the present invention. Different between the base 34 and the base 12 (shown in FIG. 1 to FIG. 6) is that the base 34 includes a plurality of buttons 35, such as the power button, the OSD (On Screen Display) button, the source selection button and so on. The third display unit 33 may have dimensional difference relative to the first display unit 11. The buttons 35 can be utilized to control the third display unit 33 when the third display unit 33 is electrically connected to the base 34.

In conclusion, the present invention utilizes separated structures such as the base and the display unit, so that the same base can be used to assemble with the display units with different dimensions; further, the display unit can be conveniently disposed on the base at different assembly directions. Comparing to the prior art, the present invention has preferred convenience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display device comprising:
a base, the base comprising a body and an accommodating portion, the accommodating portion being disposed on the body; and
a first display unit, the first display unit comprising a first casing, the first casing having a first dimension and being detachably disposed on the accommodating portion, the first display unit being electrically connected to the base when the first casing is disposed on the accommodating portion.

2. The display device of claim 1, wherein the accommodating portion comprises two vertical walls, the vertical walls are arranged in parallel to form a slot, and a first lateral side of the first casing is disposed inside the slot.

3. The display device of claim 2, wherein the base further comprises a first connector disposed inside the slot, the first display unit further comprises a second connector disposed on the first lateral side of the first casing, the first connector is matched with the second connector when the first lateral side is disposed on the accommodating portion so that the base is electrically connected to the first display unit.

4. The display device of claim 3, wherein the body further comprises a pivot hole, the accommodating portion further comprises a shaft, the accommodating portion is rotatably disposed on the body because the pivot hole is assembled with the shaft, the first display unit can be tilted relative to the base when the first lateral side is disposed on the accommodating portion.

5. The display device of claim 3, wherein the first display unit further comprises a third connector disposed on a second lateral side of the first casing, the first connector is matched with the third connector when the second lateral side is disposed on the accommodating portion so that the base is electrically connected to the first display unit.

6. The display device of claim 5 wherein the first lateral side and the second lateral side of the first display unit are adjacent to each other.

7. The display device of claim 5, wherein the second connector and the third connector are female connectors, and the first connector is a male connector.

8. The display device of claim 4, wherein the first display unit further comprises a third connector disposed on a second lateral side of the first casing, the first connector is matched with the third connector when the second lateral side is disposed on the accommodating portion so that the base is electrically connected to the first display unit.

9. The display device of claim 8 wherein the first lateral side and the second lateral side of the first display unit are adjacent to each other.

10. The display device of claim 8, wherein the second connector and the third connector are female connectors, and the first connector is a male connector.

11. The display device of claim 1, wherein the base further comprises a plurality of buttons, the first display unit is controlled by the buttons when the first display unit is electrically connected to the base.

12. The display device of claim 1, further comprising:
a second display unit, the second display unit comprising a second casing, the second casing having a second dimension and being fit for the accommodating portion, the second display unit being electrically connected to the base when the first display unit is disassembled from the base and the second casing is disposed on the accommodating portion.

13. The display device of claim 5, further comprising:
a second display unit, the second display unit comprising a second casing, the second casing having a second dimension and being fit for the accommodating portion, the second display unit being electrically connected to the base when the first display unit is disassembled from the base and the second casing is disposed on the accommodating portion.

14. The display device of claim 8, further comprising:
a second display unit, the second display unit comprising a second casing, the second casing having a second dimension and being fit for the accommodating portion, the second display unit being electrically connected to the base when the first display unit is disassembled from the base and the second casing is disposed on the accommodating portion.

15. The display device of claim 12 wherein the first dimension is substantially greater than the second dimension.

16. The display device of claim 13 wherein the first dimension is substantially greater than the second dimension.

17. The display device of claim 14 wherein the first dimension is substantially greater than the second dimension.
